(19) United States
(12) Patent Application Publication
(10) Pub. No.: US 2006/0061452 A1
(43) Pub. Date: Mar. 23, 2006

(54) Control system, control device, control method, wireless tag and wireless tag information management method

(75) Inventors: Hironobu Nagayama, Kanagawa (JP); Shigeki Muramatsu, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/218,491

(22) Filed: Sep. 6, 2005

(30) Foreign Application Priority Data
Sep. 21, 2004 (JP) 2004-273456

(51) Int. Cl. H04Q 5/22

(52) U.S. Cl. 340/10.5; 455/556.1; 340/5.61; 340/572.1

(57) ABSTRACT

A control system which includes a wireless tag having control information, and a control device having a wireless tag reader that reads the information from the wireless tag, and an equipment controller that obtains the control information and controls equipment according to the control information.

### BACKGROUND OF THE INVENTION

1. Field of the Invention

The present invention relates to a control system, a control device, a control method, a wireless tag and a wireless tag information management method, and more particularly to a control system capable of controlling a wireless tag or an operation using a wireless tag reader or controlling reading of information recorded in the wireless tag, a control device, a control method, a wireless tag and a wireless tag information management method.

2. Description of the Related Art

When a wireless tag such as an RFID (Radio Frequency Identification), an IC (Integrated Circuit) tag or the like receives radio waves from a wireless tag reader, it provides the wireless tag reader with information recorded in the wireless tag.

Because the wireless tag reader is provided with the information under no conditions, there is a possibility that the wireless tag reader reads unnecessary information and a system using the information read from the wireless tag is disrupted, the information is read freely from the wireless tag without being realized by a user, or the like.

As a method to prevent information from being read from the wireless tag, there are proposed a method of disabling reading of information by using an intense electromagnetic wave and a method of additionally mounting an inherent.

There is a problem of a public nuisance resulting from a bad manner of forgetting to turn off a cellular phone in a train, a bus, a movie theater or the like in these years. Especially, if there is such a bad manner near a priority seat in a train or in an airplane, there is a possibility of having serious effects on medical equipment such as a pacemaker or airplane instruments.

Art museums, museums, book stores and the like are faced with a problem of photographing by a camera-equipped cellular phone and a camera.

But, a method of disabling reading of information by means of an intense electromagnetic wave or a method of additionally mounting an inherent device had a disadvantage that a wireless tag could not be reused or an additional cost incurred.

The use of a cellular phone, a camera or the like highly depends on people, and it is substantially impossible to thoroughly eliminate a bad manner.

### SUMMARY OF THE INVENTION

The present invention has been made in view of the above circumstances and provides a control system, a control device, a control method, a wireless tag and a wireless tag information management method, which can limit reading of information or the use of equipment not intended by a user.

An aspect of the present invention provides a control system which includes a wireless tag having control information, and a control device having a wireless tag reader that reads the information from the wireless tag, and an equipment controller that obtains the control information and controls equipment according to the control information.

### BRIEF DESCRIPTION OF THE DRAWINGS

Embodiments of the present invention will be described in detail based on the following figures, wherein:

FIG. 1 is an outline functional block diagram showing a structure of a control system according to a first embodiment of the present invention;

FIG. 2 is a flow chart showing a flow of processing of the control device according to the first embodiment;

FIG. 3A, FIG. 3B and FIG. 3C are schematic diagrams showing an operation of a control system when a camera is used as equipment and a wireless tag is installed near a painting of which photographing is prohibited;

FIG. 4 is an outline functional block diagram showing a structure of a control system according to a second embodiment of the present invention;

FIG. 5 is a flow chart showing a flow of processing by a control device according to the second embodiment;

FIG. 6 is a functional block diagram showing a structure of the camera according to a third embodiment;

FIG. 7 is a flow chart showing a flow of processing by the camera according to the third embodiment;

FIG. 8 is a functional block diagram showing an example of a structure of a control system according to a fourth embodiment;

FIG. 9 is a functional block diagram showing an example of a structure of a control system when a camera is used as equipment;

FIG. 10 is a flow chart showing a flow of processing of a camera when the camera is used as equipment and photographing is conducted according to control information;

FIG. 11 is a functional block diagram showing an example of a structure of a camera according to a fifth embodiment;

FIG. 12 is a flow chart showing a flow of processing of the camera according to the fifth embodiment;

FIG. 13 is a functional block diagram showing a structure of a wireless tag according to a sixth embodiment;

FIG. 14 is a flow chart showing a flow of processing of the wireless tag according to the sixth embodiment;

FIG. 15 is a functional block diagram showing a structure of a wireless tag according to a seventh embodiment;

FIG. 16 is a flow chart showing a flow of processing to read information according to the seventh embodiment; and

FIG. 17 is a flow chart showing a flow of processing of a wireless tag according to an eighth embodiment.

### DETAILED DESCRIPTION OF THE INVENTION

Embodiments of a control system, a control device, a control method, a wireless tag and a wireless tag information management method according to the present invention will be described in detail with reference to the accompanying drawings.

### First Embodiment

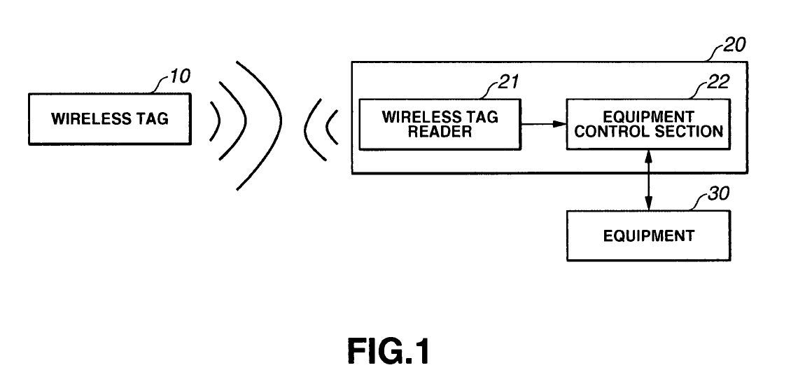

FIG. 1 is an outline functional block diagram showing a structure of a control system according to a first embodiment of the present invention.

As shown FIG. 1, the control system of the present invention comprises a wireless tag 10 and a control device 20, and equipment 30 for controlling is connected to the control device 20.

And, control information for controlling the equipment 30 by the control device 20 is recorded in the wireless tag 19.

The control device 20 is provided with a wireless tag reader 21 and an equipment control section 22.

The wireless tag reader 21 emits radio waves and reads information which is recorded in the wireless tag 10.

The equipment control section 22 controls the wireless tag reader 21 and obtains control information from the information read by the wireless tag reader 21. And, the equipment control section 22 controls the equipment 30 according to the control information.

The equipment 30 is equipment for receiving control by the control device 20 and can be any type of equipment such as a camera, a cellular phone or the like.

By configuring as described above, the control system of the present invention reads the control information recorded in the wireless tag by the control device and stops a function of the equipment.

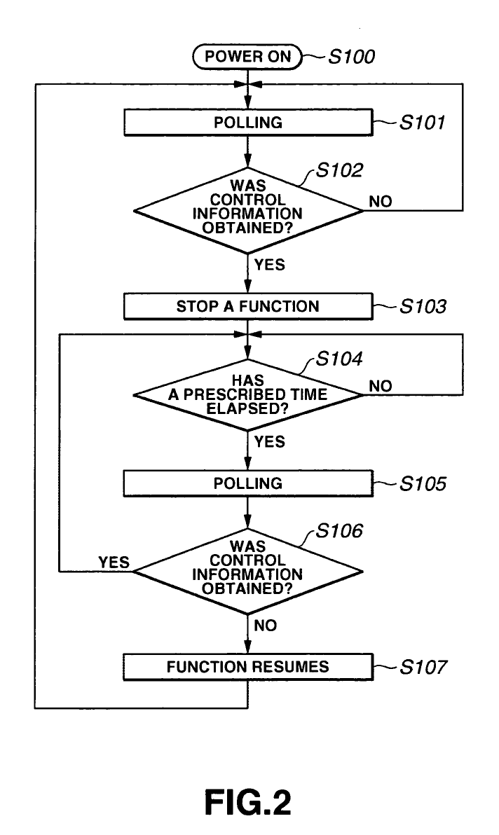

FIG. 2 is a flow chart showing a flow of processing of the control device according to this embodiment.

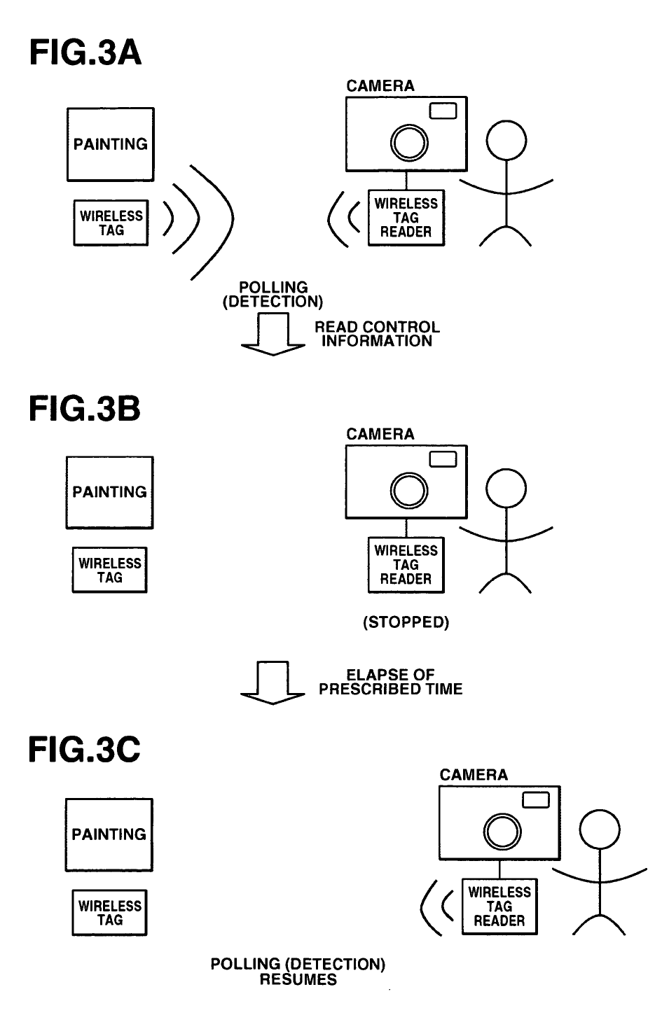

First, when the equipment is powered on (step 100), radio waves are emitted from the wireless tag reader to conduct polling (see FIG. 3A) (step 101), and when control information is obtained (YES in step 102), a function of the equipment is stopped (see FIG. 3B) (step 103), and if the control information cannot be obtained (NO in step 102), polling is conducted again (step 101).

After the function is stopped in step 103 and a prescribed time elapses (YES in step 104), polling is conducted (step 105), control information is obtained (YES in step 106), the passage of a prescribed time is waited (step 104), and if the control information cannot be obtained (see FIG. 3C) (NO in step 106), the function of the equipment is resumed (step 107), and polling is conducted again (step 101).

FIG. 3 A, FIG. 3B and FIG. 3C are schematic diagrams showing an operation of a control system when a camera is used as equipment and a wireless tag is installed near a painting of which photographing is prohibited. FIG. 3C shows a state that control information cannot be obtained because a user completes appreciating the fainting and leaves that spot while the polling is suspended.

In this embodiment, the polling is conducted again after the lapse of a prescribed period of time after the function is stopped, but the polling may be conducted continuously, or the intensity of waves received from the wireless tag may be measured to stop the function of the equipment depending on the measured intensity.

In addition, when the function is stopped, the function may be resumed manually by the user without polling, and the equipment may be turned off in step 103.

According to this embodiment, the function of the equipment is stopped when the control information is obtained from the wireless tag. Therefore, for example, when the wireless tag is disposed on a priority seat or within an airplane, and the control device is connected to a cellular phone, the cellular phone can be prevented from being used near the priority seat or within the airplane.

In the first embodiment, the wireless tag reader is provided on the side of the control device, but it may be configured to have an IC tag on the side of the control device and to detect a sensing signal to be sent at the time of polling by the wireless tag reader to control the equipment. Such a configuration will be described in a second embodiment below.

### Second Embodiment

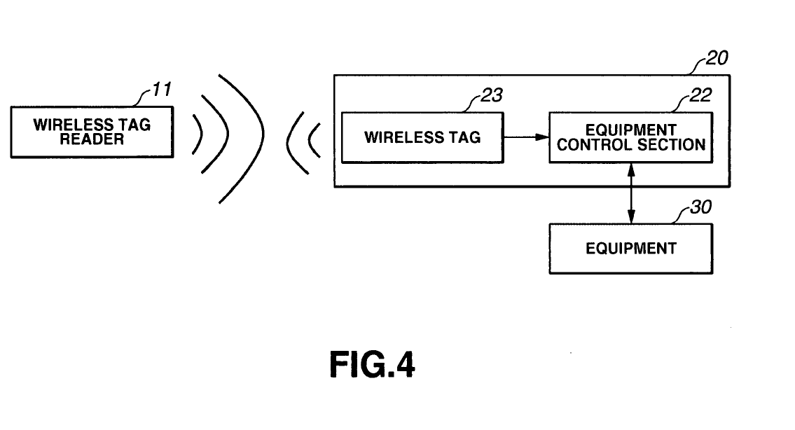

FIG. 4 is an outline functional block diagram showing a structure of a control system according to a second embodiment of the present invention.

As shown in FIG. 4, the control system according to the present invention comprises a wireless tag reader 11 and the control device 20, and the equipment 30 for controlling is connected to the control device 20.

And, the control device 20 is provided with a wireless tag 23 and the equipment control section 22.

Like parts which function in the same manner as those of FIG. 1 are denoted by like reference numerals as those used in FIG. 1, and detailed descriptions thereof will be omitted.

The equipment control section 22 monitors the intensity of a sensing signal received by the wireless tag 23 and controls the function of the equipment 30 depending on the monitored intensity.

The wireless tag 23 receives the sensing signal.

By configuring as described above, the control system of the present invention monitors the intensity of the sensing signal and stops the function of the equipment if the intensity increases (the wireless tag leader comes closer).

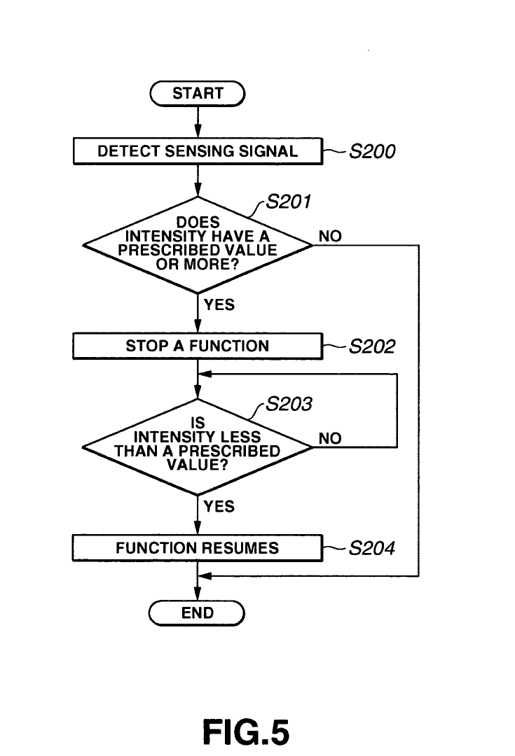

FIG. 5 is a flow chart showing a flow of processing by a control device according to this embodiment.

First, a sensing signal is received (step 200), the intensity of the sensing signal is judged (step 201), and if the intensity has a prescribed value or more (YES in step 201), the function of the equipment is stopped (step 202), and if the intensity is less than the prescribed value (NO in step 201), the process is terminated.

When the intensity of the sensing signal is less than the prescribed value (YES in step 203) after the function is stopped in step 202, the function of the equipment is resumed (step 204).

According to this embodiment, the function of the equipment can be controlled depending on the intensity of the sensing signal from the wireless tag reader, so that the equipment can be controlled depending on a distance or the like to stop the function of the equipment if the distance becomes shorter than a prescribed distance.

In the first and second embodiments, when the control information is obtained, the function is stopped, but when the control information is used to control in the same way as in the first embodiment, the contents of control may be changed according to the control information.

For example, when a camera is connected as the equipment, it is possible to stop a particular function such as a flash or to prohibit recording in a medium. A camera provided with the control device which was described in the first embodiment will be described in detail with reference to a third embodiment.

### Third Embodiment

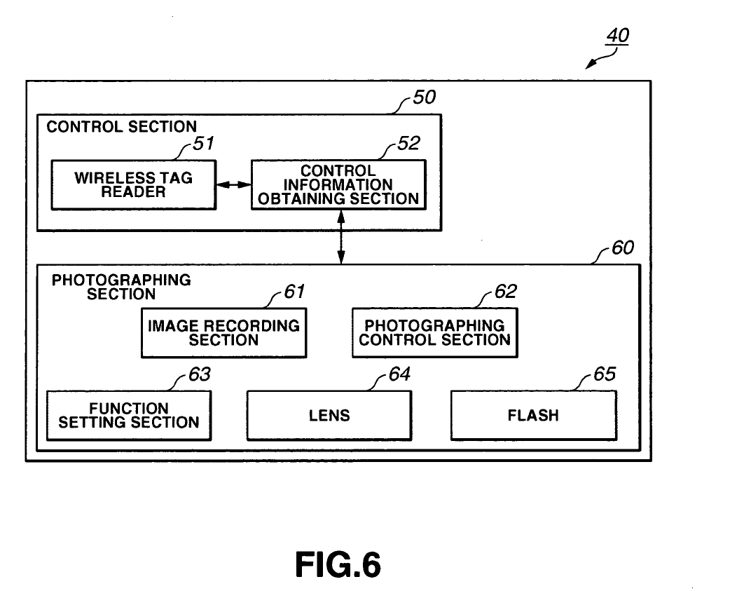

FIG. 6 is a functional block diagram showing a structure of the camera according to this embodiment.

As shown in FIG. 6, a camera 40 is comprised of a control section 50 and a photographing section 60.

The control section 50 is provided with a wireless tag reader 51 and a control information obtaining section 52.

The wireless tag reader 51 emits radio waves and reads information recorded in an unshown wireless tag.

The control information obtaining section 52 controls the wireless tag reader 51 and also obtains control information from the information read by the wireless tag reader 51. And, the control information obtaining section 52 controls the photographing section 60 according to the obtained control information.

And, the control section 50 reads the control information recorded in the wireless tag and controls the photographing section according to the control information.

The photographing section 60 is provided with an image recording section 61, a photographing control section 62, a function setting section 63, a lens 64 and a flash 65.

The image recording section 61 records a photographed image on a film or a medium.

The photographing control section 62 controls the whole photographing section to photograph.

The setting section 63 determines functions for photographing, such as no flash use, photographing mode and the like.

And, the photographing section 60 photographs a subject and records the photographed image. In other words, it functions as an ordinary camera.

By configuring as described above, the camera of this embodiment reads control information recorded in a wireless tag by the control section and controls the function according to the control information.

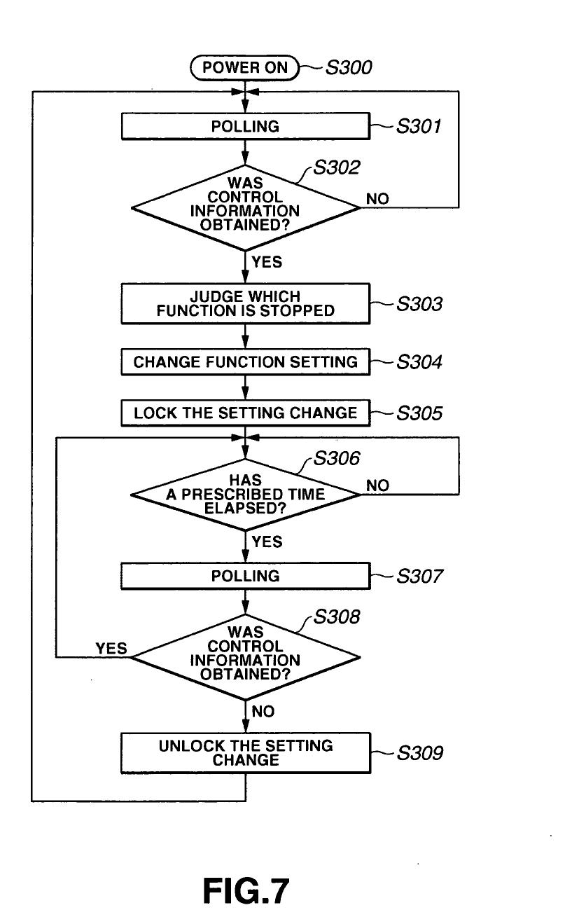

FIG. 7 is a flow chart showing a flow of processing of the camera according to this embodiment.

First, the camera is powered on (step 300), the wireless tag reader emits radio waves to conduct polling (step 301), and control information is obtained (YES in step 302), it is judged according to the control information which function is stopped (step 303), the settings of the function setting section are changed (step 304), and the setting change of the functions of which settings are changed is locked (step 305).

Meanwhile, if control information cannot be obtained (NO in step 302), polling is conducted again (step 301).

And, when the setting change is locked in step 305 and a prescribed period of time elapses (YES in step 306), polling is conducted (step 307), control information is obtained (YES in step 308), the lapse of the prescribed period of time is waited (step 306), and if control information cannot be obtained (NO in step 308), the setting change is unlocked (step 309), and polling is conducted again (step 301).

The embodiment described above judges according to the control information which function is stopped, so that only a particular function such as a flash can be stopped.

For example, when it is assumed that the flash function is stopped in order to lock the setting change while the camera is photographing in a so-called auto-mode that the camera sets automatically conditions optimum for photographing, the optimum photographing conditions are determined in a state not using the flash while the function is stopped, and when the setting change is unlocked, and optimum photographing conditions are set under the condition that the flash can be used.

Therefore, the camera can be controlled such that the user can photograph under optimum conditions within the limited conditions.

In this embodiment, the setting change is unlocked in step 309, but the settings before the change may be recorded at the time of changing the function settings in step 304 and the conditions before the change may be resumed in step 309.

The photographing control section may be controlled to inhibit recording in a medium in step 304. By configuring in this way, photographing can be made but recording in the medium cannot be made immediately, so that the number of photographing can be limited to one.

In addition, the photographing control section may be controlled not to accept an operation of the shutter or the like in step 304 so as to stop the function of the camera (equipment) itself, namely the photographing function itself, in the same manner as in the first embodiment, and it may be further configured to power off the camera in step 304 not to conduct the following process.

In this embodiment, the control device described in the first embodiment is determined as the control section and disposed on the camera (equipment) to control the functions but, for example, a cellular phone is used as equipment to set to a manner mode according to the control information, and any equipment can be used to perform desired control.

In the third embodiment, a particular function is inhibited from being used when the control information is obtained, but it may be configured to perform a particular operation when the control information is obtained. Such a configuration will be described with reference to a fourth embodiment below.

### Fourth Embodiment

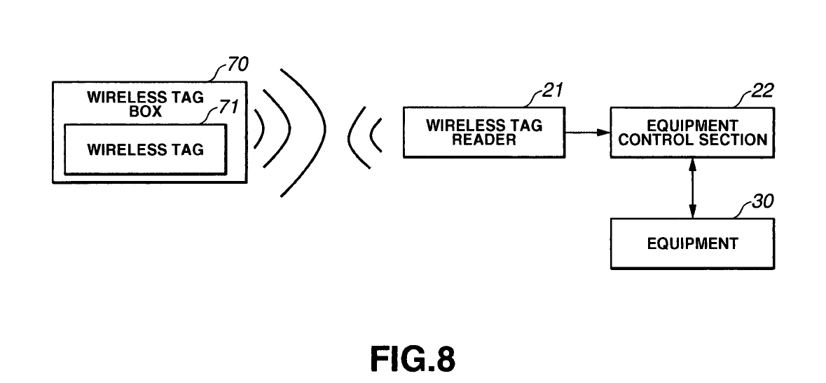

FIG. 8 is a functional block diagram showing an example of a structure of a control system according to this embodiment.

As shown in FIG. 8, the control system of this embodiment has the wireless tag reader 21 disposed in a position capable of polling a wireless tag 71 accepted by a wireless tag box 70 and connects the equipment control section 22 and the equipment 30.

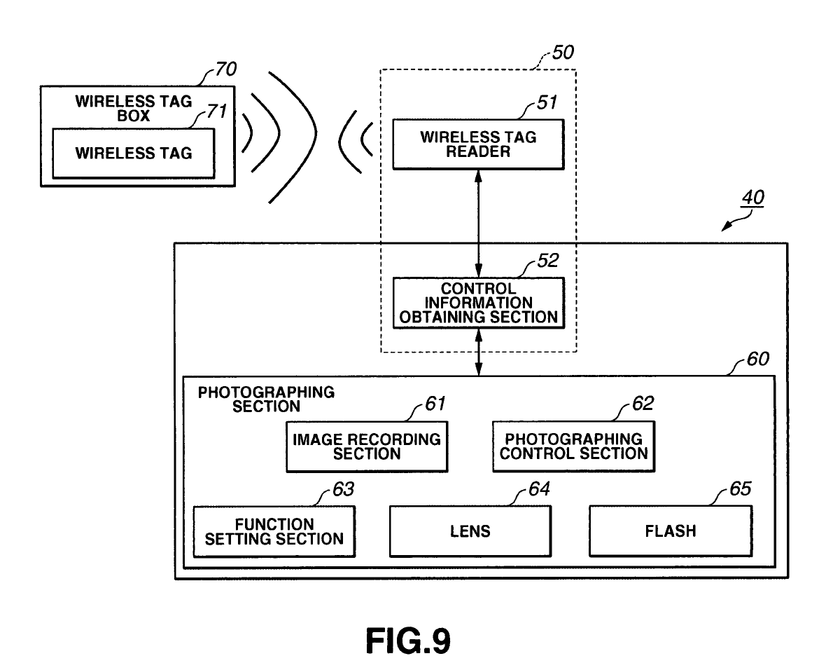

FIG. 9 is a functional block diagram showing an example of a structure of a control system when a camera is used as equipment.

As show in FIG. 9, the camera 40 is provided with the control information obtaining section 52 of the control section 50 and the photographing section 60. The wireless tag reader 51 of the control section 50 is disposed in a position capable of polling the wireless tag accepted by the wireless tag box.

Like parts which function in the same manner as those of FIG. 6 are denoted by like reference numerals as those used in FIG. 6, and detailed descriptions thereof will be omitted.

The wireless tag box 70 fixes the wireless tag 71 in a prescribed position.

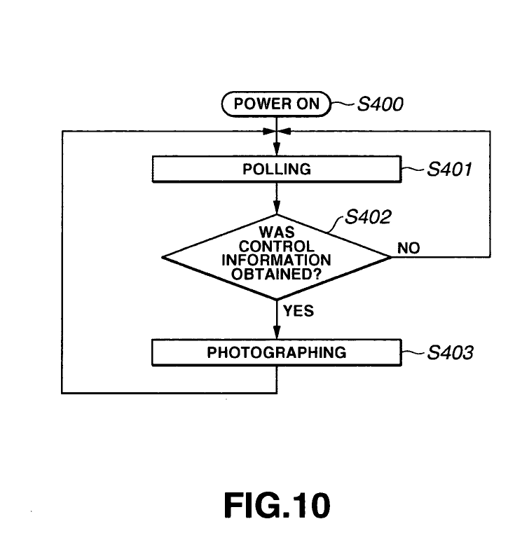

FIG. 10 is a flow chart showing a flow of processing of a camera when the camera is used as equipment and photographing is conducted according to the control information.

First, the equipment is powered on (step 400), the wireless tag reader emits radio waves, and polling is conducted (step 401).

If control information cannot be obtained (NO in step 402), polling is conducted again (step 401).

Meanwhile, if control information is obtained (YES in step 402), photographing is conducted (step 403), then polling is conducted again (step 401).

Thus, in this embodiment, the wireless tag box receives the wireless tag, and the camera is used for photographing.

For example, the wireless tag box is mounted on a roller coaster train, the camera is mounted in a prescribed position of the track, and the wireless tag reader is disposed in a position capable of polling the wireless tag which is accepted by the wireless tag box when the train passes by. Thus, it is possible to control whether people in the train are photographed or not when the train passes by the wireless tag reader.

The control device is used to control the camera in this embodiment, but the equipment is not limited to the camera. For example, it may be configured that an audio guide device is used as the equipment, and an audio guide is started when a user having a prescribed wireless tag passes by the wireless tag reader.

### Fifth Embodiment

This embodiment is configured such that the equipment is provided with the wireless tag box so not to receive a limit to particular control information.

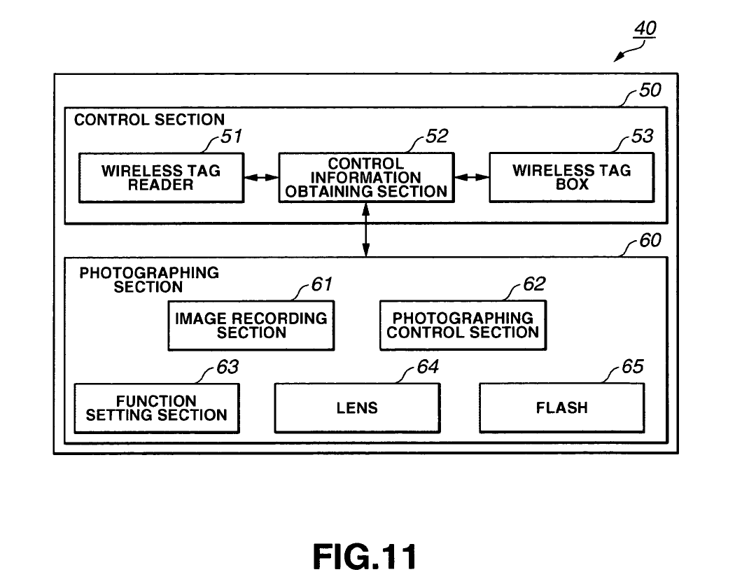

FIG. 11 is a functional block diagram showing an example of a structure of a camera according to this embodiment.

As shown in FIG. 11, the camera 40 comprises the control section 50 and the photographing section 60.

Like parts which function in the same manner as those of FIG. 6 are denoted by like reference numerals as those used in FIG. 6, and detailed descriptions thereof will be omitted.

The control section 50 is provided with the wireless tag reader 51, the control information obtaining section 52 and a wireless tag box 53.

The wireless tag box 53 accepts an unshown wireless tag, and control conditions recorded in the wireless tag conditions are read by an unshown wireless tag reader.

Here, the control conditions determine a function which is not limited even if functions are limited their use by the control information, and such a function is, for example, a photographing permit, zoom, macro or flash use permit, medium writing permit, or the like.

The control information obtaining section 52 controls the photographing section 60 according to the control information obtained from the information read by the wireless tag reader 51 and the control conditions obtained from the wireless tag accepted by the wireless tag box 53.

And, the control section 50 obtains control information from the wireless tag which is disposed outside of the camera and also obtains control conditions from the wireless tag accepted by the wireless tag box and controls the photographing section 60 according to the obtained control information and control conditions.

By configuring as described above, the camera of this embodiment obtains the control information and controls the functions of the camera according to the obtained control information and control conditions.

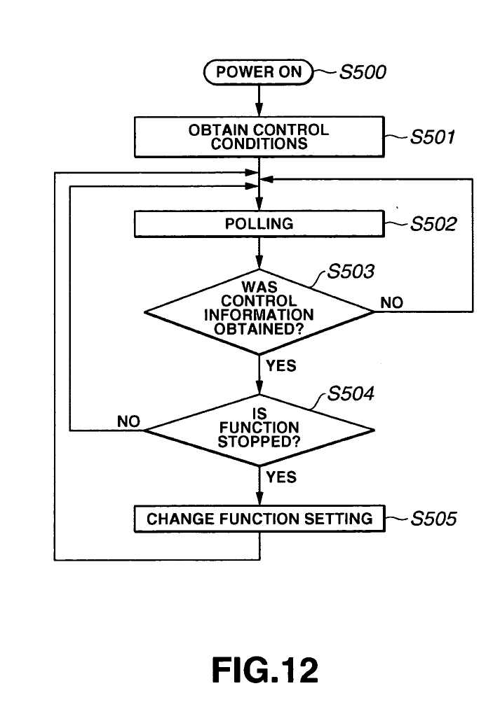

FIG. 12 is a flow chart showing a flow of processing of the camera according to this embodiment.

First, the camera is powered on (step 500), the wireless tag is charged into the wireless tag box, and control conditions are obtained from the wireless tag (step 501).

Radio waves are emitted from the wireless tag reader to conduct polling (step 502), and if control information cannot be obtained (NO in step 502), the polling is conducted again (step 502), and when the control information is obtained (YES in step 503), it is judged according to the control conditions whether or not the function instructed by the control information is stopped (step 504).

Here, when it is judged that the function is not stopped (NO in step 504), the polling is conducted again (step 502), and when it is judged that the function is stopped (YES in step 504), the settings of the function setting section are changed (step 505), and the polling is conducted again (step 502).

As described above, the camera (equipment) is controlled according to the control information and the control conditions in this embodiment. For example, it may be configured such that photographing in an art museum is permitted by paying a fee at a ticket office of the museum without evenly controlling all the equipment but only particular equipment can be controlled.

### Sixth Embodiment

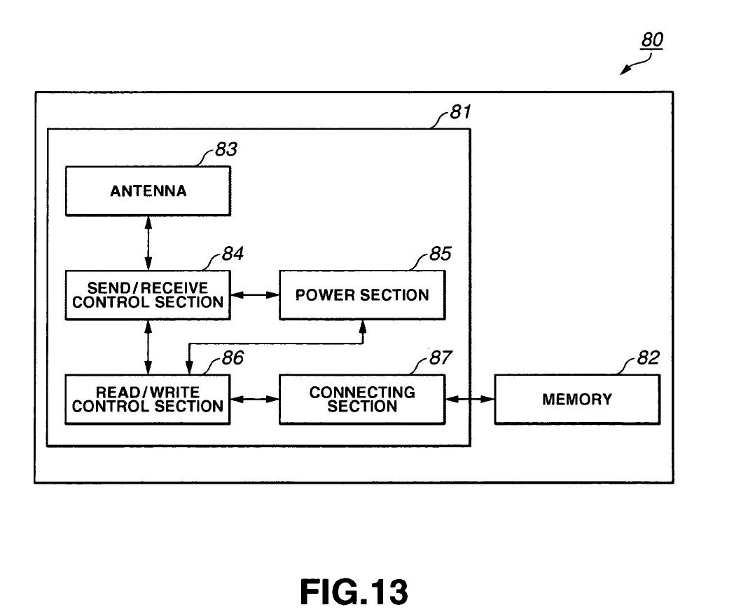

FIG. 13 is a functional block diagram showing a structure of a wireless tag according to this embodiment.

As shown in FIG. 13, a wireless tag 80 is comprised of a wireless tag chip section 81 disposed on a chip and a memory 82 removable from the chip.

The wireless tag chip section 81 is provided with an antenna 83, a send/receive control section 84, a power section 85, a read/write control section 86 and a connecting section 87.

The antenna 83 receives radio waves emitted from an unshown wireless tag reader.

The send/receive control section 84 is connected to the antenna 83 and controls for sending and receiving information to and from the wireless tag reader.

The power section 85 uses the power of the radio waves received by the antenna 83 to generate D.C. voltage for operating the individual sections.

The read/write control section 86 judges whether it is connected to the memory 82 and also controls to read and write information.

The connecting section 87 is a general-purpose or dedicated connection terminal to connect the memory 82 and the wireless tag chip section 81.

And, the wireless tag chip section 81 reads information recorded in the memory 82 and writes information in the memory 82.

The memory 82 records information being held by the wireless tag.

By configuring as described above, upon receiving radio waves from the wireless tag reader, the wireless tag of this embodiment judges the connection of the memory and conducts processing.

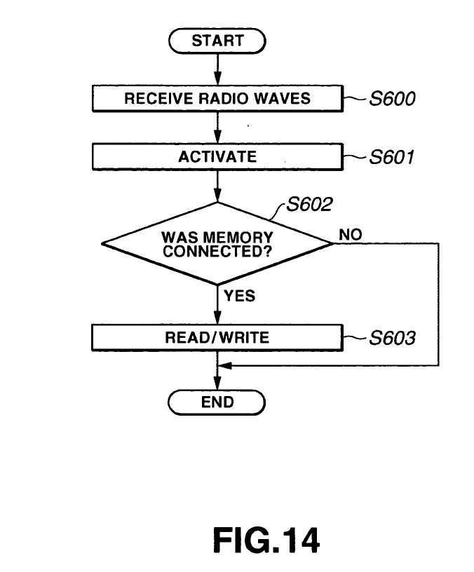

FIG. 14 is a flow chart showing a flow of processing of the wireless tag according to this embodiment.

First, upon receiving radio waves from a wireless tag reader or writer (step 600), the wireless tag activates (step 601) and judges whether a memory is connected or not (step 602).

And, when it is judged that the memory is not connected (NO in step 602), the processing is terminated, and when it is judged that the memory is connected (YES in step 602), reading of information from the memory or writing of information into the memory is conducted (step 603).

Thus, this embodiment can remove the memory, so that writing or reading of information not intended by a user can be prevented.

### Seventh Embodiment

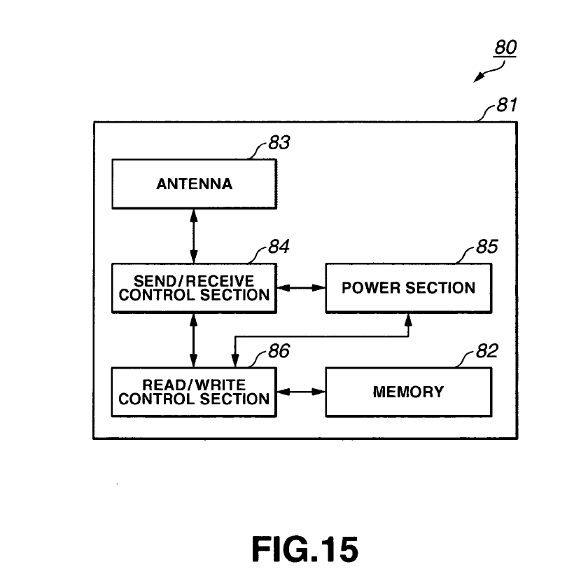

FIG. 15 is a functional block diagram showing a structure of a wireless tag according to this embodiment.

As shown in FIG. 15, the wireless tag 80 is provided with the memory 82, the antenna 83, the send/receive control section 84, the power section 85 and the read/write control section 86.

Like parts which function in the same manner as those of FIG. 13 are denoted by like reference numerals as those used in FIG. 13, and detailed descriptions thereof will be omitted.

The read/write control section 86 reads information according to a control code recorded in the memory 82.

By configuring as described above, when a control code is sent from the wireless tag writer, the wireless tag of this embodiment records the pertinent control code and reads information according to the control code when information is read from the wireless tag reader.

The individual sections in FIG. 15 are formed on a chip, but the wireless tag from which a memory or the like can be removed as described in the sixth embodiment may be used.

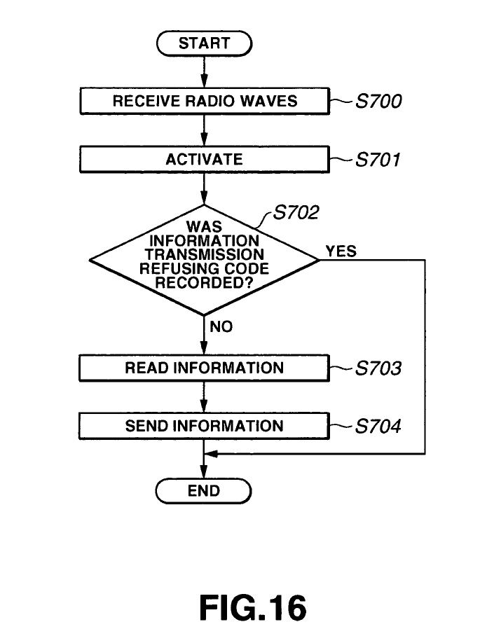

FIG. 16 is a flow chart showing a flow of processing when information is read from the wireless tag according to this embodiment.

First, upon receiving radio waves from the wireless tag reader (step 700), the wireless tag activates (step 701) and judges whether a control code which refuses readout is recorded or not (step 702).

And, when it is judged that the control code which refuses readout is recorded (YES in step 702), the processing is terminated, and when it is judged that the control code which refuses readout is not recorded (NO in step 702), information is read from the memory (step 703), and the information is sent to the wireless tag reader (step 704).

In this embodiment, the processing is terminated if a control code is not recorded, but it may be configured such that dummy information is sent, or information indicating that information is not recorded is sent, thereby sending any information other than the proper information.

As described above, this embodiment uses a control code to prevent reading of information, so that reading of information not intended by a user can be prevented.

And, the control code for permitting reading of information is recorded in the memory by a wireless tag writer, so that reading of the information can be permitted, and the wireless tag can be reused.

### Eighth Embodiment

In this embodiment, an identifier of a readable wireless tag reader or writer is recorded in the memory, and reading or writing of information is permitted according to the identifier when an information reading or writing request is received via radio waves.

The wireless tag of this embodiment is the same as the wireless tag of the seventh embodiment except that the identifier of a wireless tag reader or writer is recorded in the memory 82, the identifier received from the wireless tag reader or writer and the identifier recorded in the memory are compared by the read/write control section 86 to read information, and detailed descriptions thereof are omitted.

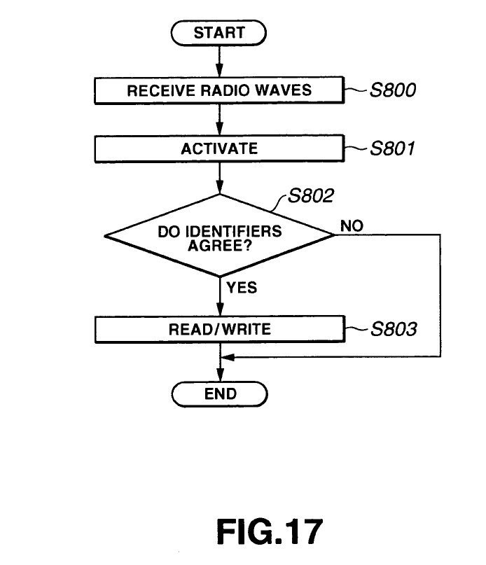

FIG. 17 is a flow chart showing a flow of processing of a wireless tag according to this embodiment.

First, upon receiving radio waves from the wireless tag reader or writer (step 800), the wireless tag activates (step 801) and judges whether or not the identifier of the wireless tag reader or writer having sent an information reading or writing request via radio waves agrees with the identifier recorded in the memory (step 802).

And, if it is judged that the identifiers do not agree (NO in step 802), the processing is terminated, and if it is judged that the identifiers agree with each other (YES in step 802), processing for reading of information from the memory or writing of information into the memory is conducted (step 803).

Thus, this embodiment can permit reading or writing of information according to the identifier of the wireless tag reader or writer, so that writing or reading of information not intended by a user can be prevented.

As described above, a first aspect of the present invention provides a control system, which includes: a wireless tag having control information; and a control device having a wireless tag reader that reads the information from the wireless tag, and an equipment controller that obtains the control information and controls equipment according to the control information.

A second aspect of the present invention provides a control system, which includes: a control device having a wireless tag and an equipment controller that controls equipment according to an intensity of a signal received by the wireless tag from a wireless tag reader; and the wireless tag reader that sends a signal to the wireless tag.

A third aspect of the present invention provides a control device, which includes: a wireless tag reader that reads information from a wireless tag, and an equipment controller that obtains control information recorded in the wireless tag and controls equipment according to the control information.

A fourth aspect of the present invention provides a control device, which includes: a wireless tag, and an equipment controller that controls equipment according to an intensity of a signal received by the wireless tag from a wireless tag reader.

A fifth aspect of the present invention provides the control device according to the third or fourth aspect of the invention, wherein the equipment may be a camera.

A sixth aspect of the present invention provides a control method, which includes: recording control information in a wireless tag, and obtaining the control information from the wireless tag and controlling equipment according to the control information.

A seventh aspect of the present invention provides a control method, which includes: controlling equipment according to intensity of a signal received by a wireless tag from a wireless tag reader.

An eight aspect of the present invention provides a wireless tag, which includes: an antenna that receives radio waves from a wireless tag reader or a writer; a power section that generates voltage from the radio waves; a read/write controller that controls reading and writing of information; and a memory that records the information, in which the memory is removable.

A ninth aspect of the present invention provides a wireless tag information management method, which includes: receiving a read request or a write request via radio waves, and processing according to the request when a memory is connected to a wireless tag.

A tenth aspect of the present invention provides a wireless tag information management method, which includes: recording a control code into a memory of a wireless tag, and terminating an information reading process when a read request is received by the wireless tag.

An eleventh aspect of the present invention provides a wireless tag information management method, which includes: recording an identifier of a wireless tag reader or a writer that permits reading or writing of information from or into a memory of a wireless tag, and colleting an identifier contained in radio waves and the identifier recorded in the memory to judge whether or not processing according to the request is to be conducted when an information reading request or an information writing request is received via the radio waves.

The above-mentioned aspects of the present invention can restrict reading of information or use of equipment not intended by a user.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-273456 filed on Sep. 21, 2004 including specification, claims, drawings and abstract is incorporated herein by reference in its entirety.

What is claimed is:

1. A control system, comprising:
a wireless tag having control information; and
a control device including a wireless tag reader that reads the information from the wireless tag, and an equipment controller that obtains the control information and controls equipment according to the control information.

2. A control system, comprising:
a control device including a wireless tag and an equipment controller that controls equipment according to an intensity of a signal received by the wireless tag from a wireless tag reader; and
the wireless tag reader which sends a signal to the wireless tag.

3. A control device, comprising:
a wireless tag reader that reads information from a wireless tag, and
an equipment controller that obtains control information recorded in the wireless tag and controls equipment according to the control information.

4. A control device, comprising:
a wireless tag, and
an equipment controller that controls equipment according to an intensity of a signal received by the wireless tag from a wireless tag reader.

5. The control device according to claim 3, wherein the equipment is a camera.

6. The control device according to claim 4, wherein the equipment is a camera.

7. A control method, comprising:
recording control information in a wireless tag, and
obtaining the control information from the wireless tag and controlling equipment according to the control information.

8. A control method, comprising:
controlling equipment according to an intensity of a signal received by a wireless tag from a wireless tag reader.

9. A wireless tag, comprising:
an antenna that receives radio waves from a wireless tag reader or a writer;
a power section that generates voltage from the radio waves;
a read/write controller that controls reading and writing of information; and
a memory that records the information, wherein:
the memory is removable.

10. A wireless tag information management method, comprising:
receiving a read request or a write request via radio waves, and
processing according to the request when a memory is connected to a wireless tag.

11. A wireless tag information management method, comprising:
recording a control code into a memory of a wireless tag, and
terminating an information reading process when a read request is received by the wireless tag.

12. A wireless tag information management method, comprising:
recording an identifier of a wireless tag reader or a writer that permits reading or writing of information from or into a memory of a wireless tag, and
colleting an identifier contained in radio waves and the identifier recorded in the memory to judge whether or not processing according to the request is to be conducted when an information reading request or an information writing request is received via the radio waves.
